(19) United States
(12) Patent Application Publication
(10) Pub. No.: US 2025/0108624 A1
(43) Pub. Date: Apr. 3, 2025

(54) PRINTING APPARATUS AND ELECTRONIC APPARATUS

(71) Applicant: SEIKO EPSON CORPORATION, Tokyo (JP)

(72) Inventor: Daisuke KURITA, Shiojiri (JP)

(21) Appl. No.: 18/896,985

(22) Filed: Sep. 26, 2024

(30) Foreign Application Priority Data
Sep. 28, 2023 (JP) 2023-167259

(51) Int. Cl. B41J 2/175; B41J 29/393

(52) U.S. Cl. CPC B41J 2/17566; B41J 29/393; B41J 2/17546

(57) ABSTRACT

A printing apparatus including a storage container that stores a liquid used in printing processing and executing the printing processing, includes an acquisition unit acquiring reuse information on a reuse history of the storage container, a generation unit, when the printing apparatus includes a recycled storage container as a recycled product of the storage container, generating contribution information related to a contribution amount to an environment with use of the recycled storage container based on the reuse information, and a device control unit controlling a display device to display the contribution amount based on the contribution information.

The present application is based on, and claims priority from JP Application Serial Number 2023-167259, filed Sep. 28, 2023, the disclosure of which is hereby incorporated by reference herein in its entirety.

### BACKGROUND

### 1. Technical Field

The present disclosure relates to a printing apparatus and an electronic apparatus.

### 2. Related Art

In related art, as disclosed in JP-A-2003-039708, a method of collecting a storage container for storing a liquid such as ink used when a printing apparatus performs printing processing and reusing the collected storage container is known.

JP-A-2003-039708 is an example of the related art.

However, in the related art, even when the storage container provided in the printing apparatus is a recycled storage container as a recycled product of the storage container, a user of the printing apparatus may not recognize that the recycled storage container is used in the printing apparatus. Accordingly, in the related art, the motivation for the user of the printing apparatus to reuse the storage container may be insufficient, and has room for improvement, of the SDGs, namely, the 17 sustainable development goals adopted in the United Nations General Assembly on Sep. 25, 2015, on Goal 13 “take urgent action to combat climate change and its impacts”, for example.

Note that the above described problem is not limited to the problem of the reuse of the storage container used in the printing apparatus, but includes, for example, in an electronic apparatus having replaceable specific components, problems in the general situations of reuse of the specific components.

### SUMMARY

A printing apparatus according to an aspect of the present disclosure is a printing apparatus including a storage container that stores a liquid used in printing processing and executing the printing processing, including an acquisition unit acquiring reuse information on a reuse history of the storage container, a generation unit, when the printing apparatus includes a recycled storage container as a recycled product of the storage container, generating contribution information related to a contribution amount to an environment with use of the recycled storage container based on the reuse information, and a device control unit controlling a display device to display the contribution amount based on the contribution information.

An electronic apparatus according to an aspect of the present disclosure is an electronic apparatus including a replaceable specific component and executing specific processing, including an acquisition unit acquiring reuse information on a reuse history of the specific component, a generation unit, when the electronic apparatus includes a recycled specific component as a recycled product of the specific component, generating contribution information related to a contribution amount to an environment with use of the recycled specific component based on the reuse information, and a device control unit controlling a display device to display the contribution amount based on the contribution information.

### BRIEF DESCRIPTION OF THE DRAWINGS

FIG. 1 is a block diagram showing an example of a configuration of a management system according to an embodiment of the present disclosure.

FIG. 2 is a block diagram showing an example of a configuration of a cartridge.

FIG. 3 is a block diagram showing an example of a configuration of a user card.

FIG. 4 is a block diagram showing an example of a configuration of a recycling box.

FIG. 5 is a block diagram showing an example of a configuration of a management server.

FIG. 6 is a block diagram showing an example of a configuration of a printing apparatus.

FIG. 7 is a block diagram showing an example of a configuration of a terminal apparatus.

FIG. 8 is a flowchart showing an example of an operation of the printing apparatus when contribution information presentation processing is executed.

### DESCRIPTION OF EMBODIMENTS

As below, embodiments for implementing the present disclosure will be described with reference to the drawings. In the respective drawings, dimensions and scales of the respective parts are made different from real ones as appropriate. The embodiments to be described are preferred specific examples of the present disclosure and various technically preferable limitations are imposed thereon. However, the scope of the present disclosure is not limited to these embodiments unless the present disclosure is particularly limited in the following description.

### A. Embodiment

In this embodiment, a management system Sys that manages cartridges 7 storing ink used in a printing apparatus 5 is explained as an example.

### 1. Configuration of Management System

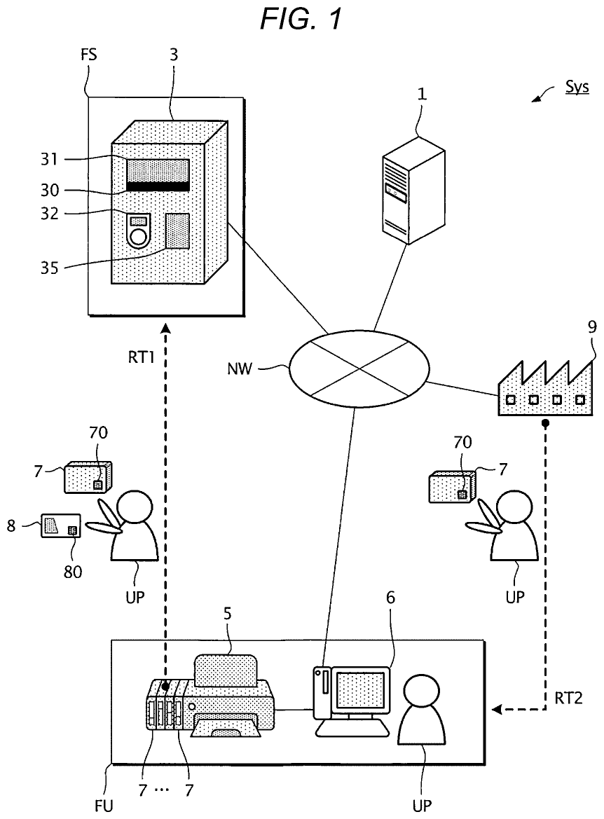

As below, an example of a configuration of the management system Sys according to the embodiment will be explained with reference to FIGS. 1 to 7.

FIG. 1 is a block diagram showing the example of the configuration of the management system Sys.

As shown in FIG. 1, the management system Sys includes a management server 1, one or more recycling boxes 3, one or more printing apparatuses 5, one or more terminal apparatuses 6 provided to correspond to the one or more printing apparatuses 5, and a recycling factory 9, and manages the cartridges 7 containing ink used in the printing apparatus 5.

The management server 1 is a server apparatus for managing the management system Sys.

The cartridge 7 is a container storing ink used in the printing apparatus 5, which can be attached to the printing apparatus 5.

In the embodiment, the ink is an example of “liquid”, and the cartridge 7 is an example of “storage container”.

The recycling box 3 is equipment for collecting a used cartridge 7 from a user UP of the printing apparatus 5. Here, the used cartridge 7 is, for example, the cartridge 7 in which a residual amount of the ink stored therein is small or the cartridge 7 in which the ink stored therein is deteriorated. That is, in the embodiment, even when the ink remains inside the cartridge 7, the recycling box 3 can collect the cartridge 7.

In the embodiment, the recycling box 3 is installed in a commercial facility FS. Here, the commercial facility FS is a commercial facility such as an electronics retail store selling the printing apparatus 5 or a shopping mall selling various commodities, a public facility such as a public hall, a medical facility such as a hospital, or the like.

Note that, in the embodiment, a case where the user UP brings the used cartridge 7 to the recycling box 3 for collection of the used cartridge 7 is assumed as an example, however, the present disclosure is not limited to the case. For example, the user UP may send the used cartridge 7 by mail to the recycling factory 9 for collection of the used cartridge 7.

The recycling factory 9 is a facility for recycling the used cartridge 7 collected from the user UP in the recycling box 3 as a recycled product. Specifically, the recycling factory 9 is a facility for manufacturing a recycled product of the cartridge 7 by cleansing the used cartridge 7 and refilling the cleansed cartridge 7 with ink as a recycled used cartridge 7. Hereinafter, the recycled product of the cartridge 7 may be referred to as “recycled cartridge 7X”.

Note that the recycling factory 9 may decompose the used cartridge 7 into materials and manufacture the recycled cartridge 7X using the decomposed materials. Further, the recycling factory 9 may decompose the used cartridge 7 into materials and manufacture a product different from the recycled cartridge 7X using the decomposed materials as a recycled product.

In the embodiment, the recycled cartridge 7X is an example of “recycled storage container”.

In the embodiment, a case where the printing apparatus 5 is provided in a user facility FU is assumed as an example. Here, the user facility FU is a facility where the user UP uses the printing apparatus 5 including a home of the user UP and an office of the user UP.

That is, in the embodiment, a case where the used cartridge 7 used in the printing apparatus 5 provided in the user facility FU is collected through a cartridge collection route RT1 from the user facility FU to the recycling box 3 is assumed. Note that, in the embodiment, for collection of the used cartridge 7 through the cartridge collection route RT1, a case where the user UP is authenticated with a user card 8 possessed by the user UP when dropping the used cartridge 7 in the recycling box 3 is assumed as an example.

Further, in the embodiment, a case where the used cartridge 7 collected through the cartridge collection route RT1 is recycled as the recycled cartridge 7X in the recycling factory 9 and delivered through a cartridge delivery route RT2 from the recycling factory 9 to the user facility FU is assumed.

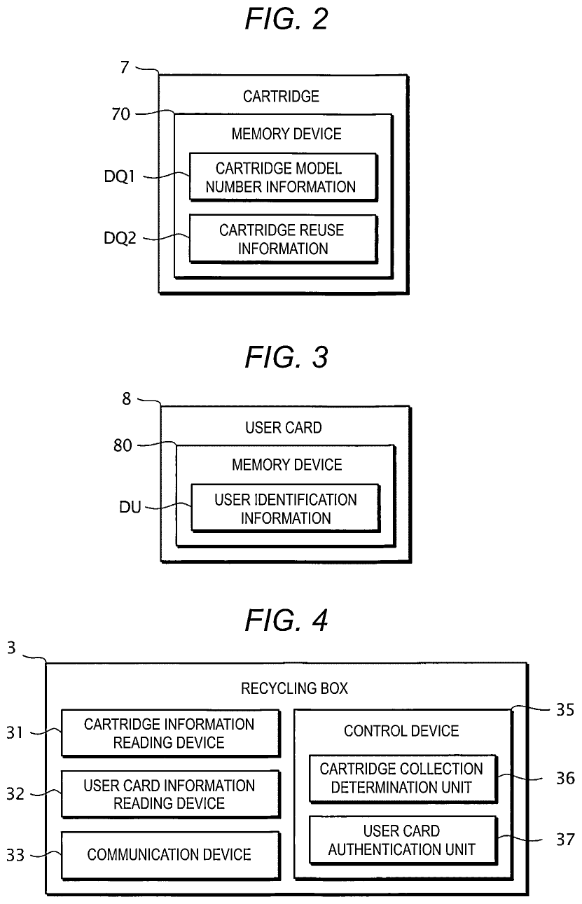

FIG. 2 is a block diagram showing an example of a configuration of the cartridge 7.

As shown in FIG. 2, the cartridge 7 includes a memory device 70. The cartridge 7 is provided with an ink storage chamber (not shown) that stores ink.

The memory device 70 is, for example, an IC chip, and stores cartridge model number information DQ1 and cartridge reuse information DQ2.

The cartridge model number information DQ1 is information indicating a product model number of the cartridge 7.

The cartridge reuse information DQ2 indicates a reuse count AQ. Here, the reuse count AQ is the number of times of recycling of the cartridge 7 as a recycled product. Specifically, the reuse count AQ is set to “0” when the cartridge 7 is a new product before recycling, and is set to a numerical value “1” or more when the cartridge 7 is a recycled product.

FIG. 3 is a block diagram showing an example of a configuration of the user card 8.

As shown in FIG. 3, the user card 8 includes a memory device 80. The memory device 80 is, for example, an IC chip, and stores user identification information DU.

The user identification information DU is information indicating a user ID for uniquely identifying each user of a plurality of users possessing the user cards 8. In the embodiment, a case where a user possessing the user card 8 is the user UP using the printing apparatus 5 is assumed. However, the present disclosure is not limited to the case. The user possessing the user card 8 may be the user UP using the printing apparatus 5 and the user using the commercial facility FS. The user possessing the user card 8 may be a user using the cartridge 7.

FIG. 4 is a block diagram showing an example of a configuration of the recycling box 3.

As shown in FIGS. 1 and 4, the recycling box 3 includes a cartridge slot 30, a cartridge information reading device 31, a user card information reading device 32, a communication device 33, and a control device 35.

The cartridge slot 30 is an opening for the user UP to drop the cartridge 7 into a cartridge storage space (not shown) provided inside the recycling box 3.

When the cartridge 7 is dropped into the cartridge slot 30, the cartridge information reading device 31 reads the cartridge model number information DQ1 and the cartridge reuse information DQ2 stored in the memory device 70 from the memory device 70 provided in the cartridge 7. However, the present disclosure is not limited to the case. When the cartridge 7 is dropped into the cartridge slot 30, the cartridge information reading device 31 may read at least the cartridge model number information DQ1 stored in the memory device 70 from the memory device 70 provided in the cartridge 7.

When the user UP touches the user card information reading device 32 with the user card 8, the user card information reading device 32 reads the user identification information DU stored in the memory device 80 from the memory device 80 provided in the user card 8.

The communication device 33 is hardware for communicating with an external device present outside the recycling box 3 via a network NW such as a wired network and a wireless network.

The control device 35 includes a cartridge collection determination unit 36 and a user card authentication unit 37.

The cartridge collection determination unit 36 determines whether an object dropped through the cartridge slot 30 corresponds to the cartridge 7 collectable by the recycling box 3 based on a reading result by the cartridge information reading device 31. Specifically, the cartridge collection determination unit 36 determines whether a model number indicated by the cartridge model number information DQ1 read by the cartridge information reading device 31 is a model number corresponding to the cartridge 7 collectable by the recycling box 3.

When the model number indicated by the cartridge model number information DQ1 read by the cartridge information reading device 31 is the model number corresponding to the cartridge 7 collectable by the recycling box 3, the cartridge collection determination unit 36 determines that the object dropped through the cartridge slot 30 corresponds to the cartridge 7 collectable by the recycling box 3. When the model number indicated by the cartridge model number information DQ1 read by the cartridge information reading device 31 is not the model number corresponding to the cartridge 7 collectable by the recycling box 3, the cartridge collection determination unit 36 determines that the object dropped through the cartridge slot 30 does not correspond to the cartridge 7 that can be collected by the recycling box 3. When the cartridge information reading device 31 fails to read the cartridge model number information DQ1, the cartridge collection determination unit 36 determines that the object dropped through the cartridge slot 30 does not correspond to the cartridge 7 collectable by the recycling box 3.

When a result of the determination by the cartridge collection determination unit 36 is positive, that is, when the object dropped through the cartridge slot 30 corresponds to the cartridge 7 collectable by the recycling box 3, the recycling box 3 stores the cartridge 7 in the cartridge storage space in the recycling box 3. Then, the cartridge 7 stored in the cartridge storage space in the recycling box 3 is periodically collected and transferred to the recycling factory 9.

On the other hand, when the result of the determination by the cartridge collection determination unit 36 is negative, that is, when the object dropped through the cartridge slot 30 does not correspond to the cartridge 7 collectable by the recycling box 3, the recycling box 3 ejects the object to the outside of the recycling box 3.

When the user card information reading device 32 is touched by the user card 8, the user card authentication unit 37 identifies the user ID of the user UP possessing the user card 8 based on the user identification information DU stored in the memory device 80 of the user card 8. The user card authentication unit 37 notifies the management server 1 of the identified user ID via the network NW. The management server 1 manages the notified user ID.

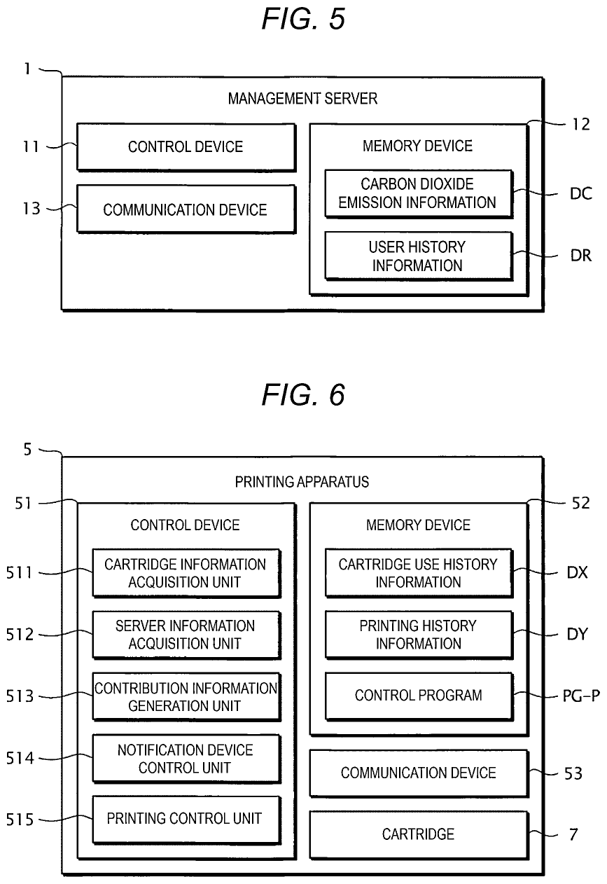

FIG. 5 is a block diagram showing an example of a configuration of the management server 1.

As shown in FIG. 5, the management server 1 includes a control device 11, a memory device 12, and a communication device 13.

The control device 11 is hardware such as a CPU (Central Processing Unit) that controls the respective parts of the management server 1.

The communication device 13 is hardware for communicating with an external device present outside the management server 1 via the network NW.

The memory device 12 includes a volatile memory such as a RAM (Random Access Memory) that functions as a work area of the control device 11 and a nonvolatile memory such as an EEPROM (Electrically Erasable Programmable Read-Only Memory) that stores various information. In the embodiment, the memory device 12 stores carbon dioxide emission information DC and user history information DR.

The carbon dioxide emission information DC includes new product carbon dioxide emission information DC1 indicating new product carbon dioxide emission AC1 and recycled product carbon dioxide emission information DC2 indicating recycled product carbon dioxide emission AC2. Here, the new product carbon dioxide emission AC1 indicated by the new product carbon dioxide emission information DC1 is an amount of the carbon dioxide emission generated in the life cycle of the new product of the cartridge 7, which includes production, distribution, use, and disposal of the new product of the cartridge 7. Further, the recycled product carbon dioxide emission AC2 indicated by the recycled product carbon dioxide emission information DC2 is an amount of the carbon dioxide emission generated in the life cycle of the recycled cartridge 7X, which includes production, distribution, use, and disposal of the recycled cartridge 7X.

The user history information DR indicates a cumulative number of uses of recycled products AR. Here, the cumulative number of uses of recycled products AR is the number of the recycled cartridges 7X used by the user

UP to the present. In the embodiment, the number of times when the user UP purchases the recycled cartridge 7X is referred to as the cumulative number of uses of recycled products AR. Further, the number of times of notification of the user ID from the recycling box 3 may be set as the cumulative number of uses of recycled products AR.

In the embodiment, the management server 1 communicates with the recycling box 3 via the network NW, and thereby, manages a collection status of the used cartridge 7 in the recycling box 3. Further, in the embodiment, the management server 1 communicates with the recycling factory 9 via the network NW, and thereby, manages a purchase status of the recycled cartridge 7X by the user UP.

FIG. 6 is a block diagram showing an example of a configuration of the printing apparatus 5.

As shown in FIG. 6, the printing apparatus 5 includes a control device 51, a memory device 52, a communication device 53, and one or more cartridges 7.

The cartridge 7 provided in the printing apparatus 5 is a new cartridge 7 or the recycled cartridge 7X. That is, of the one or more cartridges 7 provided in the printing apparatus 5, part or all may be the recycled cartridges 7X, all may be the recycled cartridges 7X, or all may be new cartridges 7.

The communication device 53 is hardware for communicating with an external device present outside the management server 1 via the network NW.

The memory device 52 includes a volatile memory such as a RAM that functions as a work area of the control device 51, and a non-volatile memory such as an EEPROM that stores various types of information. In the embodiment, the memory device 52 stores cartridge history information DX, printing history information DY, and a control program PG-P of the printing apparatus 5.

The cartridge use history information DX indicates a number of uses of recycled products AX. Here, the number of uses of recycled products AX is the number of the recycled cartridges 7X used in the printing apparatus 5 in a period from when the printing apparatus 5 is sold to the present.

The printing history information DY includes eco-printing information DY1 indicating an eco-printing count AY1 and total printing information DY2 indicating a total printing count AY2. Here, the eco-printing count AY1 indicated by the eco-printing information DY1 is, for example, the number of media on which an image is formed by the printing apparatus 5 performing printing processing using the ink stored in the recycled cartridge 7X in the period from when the printing apparatus 5 is sold to the present. Further, the total printing count AY2 indicated by the total printing information DY2 is, for example, a total value of the number of media on which an image is formed by the printing apparatus 5 performing printing processing using the ink stored in the new cartridge 7 in the period from when the printing apparatus 5 is sold to the present and the number of media on which an image is formed by the printing apparatus 5 performing printing processing using the ink stored in the recycled cartridge 7X in the period from when the printing apparatus 5 is sold to the current time.

Hereinafter, of the printing processing, the printing processing using the ink stored in the recycled cartridge 7X may be referred to as “eco-printing processing”. Further, hereinafter, of the printing processing, the printing processing using the ink stored in the new cartridge 7 may be referred to as “normal printing processing”.

The control device 51 includes a processor. The processor of the control device 51 includes, for example, one or more CPUs. In the embodiment, the processor of the control device 51 can function as a cartridge information acquisition unit 511, a server information acquisition unit 512, a contribution information generation unit 513, a notification device control unit 514, and a printing control unit 515 by executing the control program PG-P stored in the memory device 52 and operating according to the control program PG-P. The processor of the control device 51 may include hardware such as a GPU (Graphics Processing Unit), a DSP (Digital Signal Processor), or an FPGA (Field Programmable Gate Array) in addition to the one or more CPUs or instead of part or all of the one or more CPUs. In this case, part or all of functions implemented by the processor of the control device 51 may be implemented by the hardware such as a DSP.

The cartridge information acquisition unit 511 acquires the cartridge reuse information DQ2 from the memory device 70 of the cartridge 7 provided in the printing apparatus 5.

The server information acquisition unit 512 acquires the carbon dioxide emission information DC and the user history information DR from the management server 1.

In the embodiment, the cartridge information acquisition unit 511 and the server information acquisition unit 512 are examples of “acquisition unit”. However, the present disclosure is not limited to the case. One of the cartridge information acquisition unit 511 and the server information acquisition unit 512 may be “acquisition unit”.

Further, in the embodiment, the cartridge reuse information DQ2 and the user history information DR are examples of “reuse information”. However, the present disclosure is not limited to the case. One of the cartridge reuse information DQ2 and the user history information DR may be “reuse information”.

The contribution information generation unit 513 generates contribution information DK based on the cartridge reuse information DQ2 acquired by the cartridge information acquisition unit 511, the carbon dioxide emission information DC and the user history information DR acquired by the server information acquisition unit 512, and the cartridge use history information DX and the printing history information DY stored in the memory device 52.

In the embodiment, the contribution information generation unit 513 is an example of “generation unit”.

The contribution information DK includes number of attached recycled products information DK1 indicating a number of attached recycled products AK1, number of uses of recycled products information DK2 indicating a number of uses of recycled products AK2, cumulative number of uses of recycled products information DK3 indicating a cumulative number of uses of recycled products AK3, eco-printing count information DK4 indicating an eco-printing count AK4, cumulative eco-printing count information DK5 indicating a cumulative eco-printing count AK5, eco-printing ratio information DK6 indicating an eco-printing ratio AK6, carbon dioxide reduction information DK7 indicating a carbon dioxide reduction AK7, and cumulative carbon dioxide reduction information DK8 indicating a cumulative carbon dioxide reduction AK8. Hereinafter, the number of attached recycled products AK1, the number of uses of recycled products AK2, the cumulative number of uses of recycled products AK3, the eco-printing count AK4, the cumulative eco-printing count AK5, the eco-printing ratio AK6, the carbon dioxide reduction AK7, and the cumulative carbon dioxide reduction AK8 will be referred to as “environmental contribution amount AK”.

The number of attached recycled products AK1 indicated by the number of attached recycled products information DK1 is the number of recycled cartridges 7X provided in the printing apparatus 5. The contribution information generation unit 513 generates the number of attached recycled products information DK1 based on the cartridge reuse information DQ2 acquired by the cartridge information acquisition unit 511. Specifically, the contribution information generation unit 513 counts the number of the cartridges 7 for which the reuse count AQ indicated by the cartridge reuse information DQ2 is equal to or greater than “1” of the one or more cartridges 7 provided in the printing apparatus 5, and sets a result of the counting to the number of attached recycled products AK1, and thereby, generates the number of attached recycled products information DK1.

The number of uses of recycled products AK2 indicated by the number of uses of recycled products information DK2 is the number of recycled cartridges 7X used in the printing apparatus 5 in the period from when the printing apparatus 5 is sold to the present. The contribution information generation unit 513 generates the number of uses of recycled products information DK2 by setting the number of uses of recycled products AX indicated by the cartridge use history information DX stored in the memory device 52 to the number of uses of recycled products AK2. In the embodiment, when a new cartridge 7 is attached to the printing apparatus 5, the cartridge information acquisition unit 511 updates the cartridge use history information DX based on the cartridge reuse information DQ2 stored in the memory device 70 of the newly mounted cartridge 7.

In the embodiment, for convenience of description, the case where the contribution information DK includes the number of uses of recycled products information DK2 will be described as an example, however, the present disclosure is not limited to the configuration. For example, the contribution information DK may include the cartridge use history information DX in place of the number of uses of recycled products information DK2.

The cumulative number of uses of recycled products AK3 indicated by the cumulative number of uses of recycled products information DK3 is the number of recycled cartridges 7X used by the user UP to the present. The contribution information generation unit 513 generates the cumulative number of uses of recycled products information DK3 by setting the cumulative number of uses of recycled products AR indicated by the user history information DR acquired by the server information acquisition unit 512 to the cumulative number of uses of recycled products AK3.

In the embodiment, for convenience of description, the case where the contribution information DK includes the cumulative number of uses of recycled products information DK3 is described as an example, however, the present disclosure is not limited to the configuration. For example, the contribution information DK may include the user history information DR instead of the cumulative number of uses of recycled products information DK3.

The eco-printing count AK4 indicated by the eco-printing count information DK4 is the number of media on which an image is formed by the printing apparatus 5 performing the eco-printing processing using the ink stored in the recycled cartridge 7X in the period from when the printing apparatus 5 is sold to the present. The contribution information generation unit 513 generates the eco-printing count information DK4 by setting the eco-printing count AY1 indicated by the eco-printing information DY1 stored in the memory device 52 to the eco-printing count AK4. In the embodiment, when the printing apparatus 5 executes the eco-printing processing, the printing control unit 515 updates the eco-printing information DY1 based on an execution result of the eco-printing processing.

In the embodiment, for convenience of description, the case where the contribution information DK includes the eco-printing count information DK4 is described as an example, however, the present disclosure is not limited to the configuration. For example, the contribution information DK may include the eco-printing information DY1 instead of the eco-printing count information DK4.

The cumulative eco-printing count AK5 indicated by the cumulative eco-printing count information DK5 is the number of media on which an image is formed by eco-printing processing using the ink stored in the recycled cartridge 7X in the one or more printing apparatuses 5 used by the user UP to the present. The contribution information generation unit 513 calculates the cumulative eco-printing count AK5 based on the cumulative number of uses of recycled products AR indicated by the user history information DR acquired by the server information acquisition unit 512 and the eco-printing count AY1 indicated by the eco-printing information DY1 stored in the memory device 52. Specifically, the contribution information generation unit 513 calculates the cumulative eco-printing count AK5 by adding the eco-printing count AY1 to an integrated value of a value obtained by subtraction of “1” from the cumulative number of uses of recycled products AR and a standard printing count. Here, the standard printing count is an average value of the number of media on which an image can be formed by eco-printing processing using one recycled cartridge 7X.

The eco-printing ratio AK6 indicated by the eco-printing ratio information DK6 is a ratio of the number of media on which an image is formed by the eco-printing processing to the number of media on which an image is formed by the printing processing in the period from when the printing apparatus 5 is sold to the present. The contribution information generation unit 513 calculates the eco-printing ratio AK6 based on the eco-printing information DY1 stored in the memory device 52 and the total printing information DY2 stored in the memory device 52. Specifically, the contribution information generation unit 513 calculates the eco-printing ratio AK6 by dividing the eco-printing count AY1 indicated by the eco-printing information DY1 by the total printing count AY2 indicated by the total printing information DY2.

The carbon dioxide reduction AK7 indicated by the carbon dioxide reduction information DK7 is a carbon dioxide emission amount reduced by the printing apparatus 5 performing the eco-printing processing in the period from when the printing apparatus 5 is sold to the present, in comparison with that when the printing apparatus 5 performs the normal printing processing. The contribution information generation unit 513 calculates the carbon dioxide reduction AK7 based on the new product carbon dioxide emission information DC1 and the recycled product carbon dioxide emission information DC2 acquired by the server information acquisition unit 512 and the eco-printing information DY1 stored in the memory device 52.

Specifically, the contribution information generation unit 513 first calculates a reduction per cartridge by subtracting the recycled product carbon dioxide emission AC2 indicated by the recycled product carbon dioxide emission information DC2 from the new product carbon dioxide emission AC1 indicated by the new product carbon dioxide emission information DC1. Here, the reduction per cartridge is carbon dioxide emission reduced when the printing apparatus 5 performs the eco-printing processing using one recycled cartridge 7X in comparison with the case where the printing apparatus 5 performs the normal printing processing using one new cartridge 7.

The contribution information generation unit 513 calculates a reduction per medium by dividing the reduction per cartridge by the standard printing count. Here, the reduction per medium is carbon dioxide emission reduced when the printing apparatus 5 performs the eco-printing processing on one medium using the recycled cartridge 7X in comparison with a case where the printing apparatus 5 performs the normal printing processing on one medium using the new cartridge 7.

Then, the contribution information generation unit 513 calculates the carbon dioxide reduction AK7 by integrating the eco-printing count AY1 indicated by the eco-printing information DY1 and the reduction per medium.

The method of calculating the carbon dioxide reduction AK7 according to the embodiment is an example, and the present disclosure is not limited to the configuration. For example, the contribution information generation unit 513 may calculate the carbon dioxide reduction AK7 by integrating the number of uses of recycled products AX indicated by the cartridge use history information DX and the reduction per cartridge.

The cumulative carbon dioxide reduction AK8 indicated by the cumulative carbon dioxide reduction information DK8 is carbon dioxide emission reduced by the eco-printing processing in comparison with a case where the normal printing processing is performed in the one or more printing apparatuses 5 used by the user UP to the present. The contribution information generation unit 513 calculates the cumulative carbon dioxide reduction AK8 based on the user history information DR, the new product carbon dioxide emission information DC1, and the recycled product carbon dioxide emission information DC2 acquired by the server information acquisition unit 512 and the eco-printing information DY1 stored in the memory device 52. Specifically, the contribution information generation unit 513 calculates the cumulative carbon dioxide reduction AK8 by adding an integrated value obtained by integration of the reduction per cartridge to a value obtained by subtraction of “1” from the cumulative number of uses of recycled products AR indicated by the user history information DR and an integrated value obtained by integration of the reduction per medium to the eco-printing count AY1 indicated by the eco-printing information DY1.

The notification device control unit 514 controls the terminal apparatus 6 for notification of the environmental contribution amount indicated by the contribution information DK generated by the contribution information generation unit 513 via the terminal apparatus 6. Specifically, the notification device control unit 514 notifies the terminal apparatus 6 of the environmental contribution amount AK by supplying the contribution information DK to the terminal apparatus 6. Hereinafter, processing of generating the contribution information DK and notifying the terminal apparatus 6 of the environmental contribution amount AK indicated by the generated contribution information DK in the control device 51 is referred to as “contribution information presentation processing”.

In the embodiment, the notification device control unit 514 is an example of “device control unit”.

The printing control unit 515 executes printing processing of forming an image on a medium by controlling a printing head (not shown) provided in the printing apparatus.

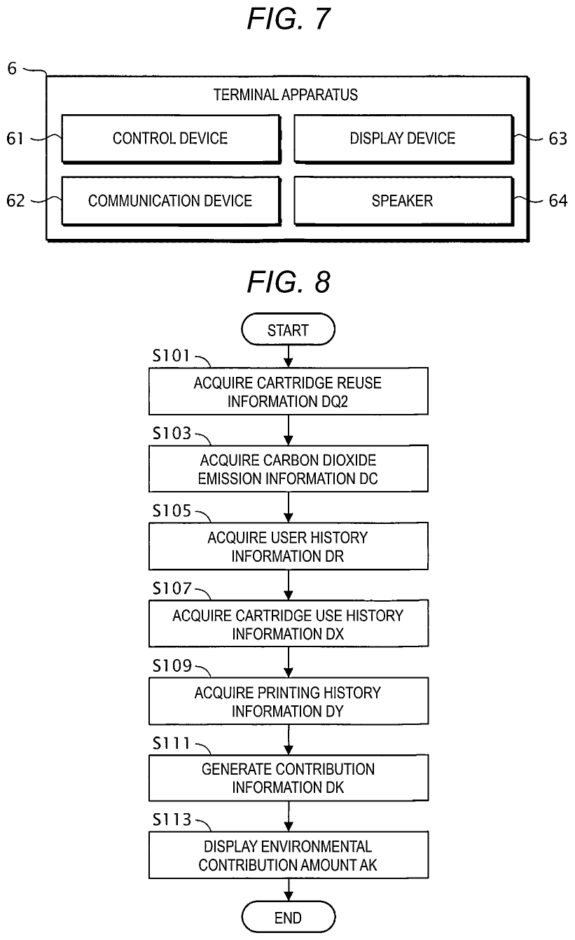

FIG. 7 is a block diagram showing an example of a configuration of the terminal apparatus 6.

As shown in FIG. 7, the terminal apparatus 6 includes a control device 61, a communication device 62, a display device 63, and a speaker 64.

The control device 61 is hardware such as a CPU that controls the respective parts of the terminal apparatus 6.

The communication device 62 is hardware for communicating with an external device present outside the terminal apparatus 6 via the network NW.

The display device 63 is hardware for displaying an image under control of the control device 61.

The speaker 64 is hardware for generating sound under control of the control device 61.

When the contribution information DK is supplied from the printing apparatus 5, the control device 61 controls the display device 63 to display the environmental contribution amount AK, and controls the speaker 64 to emit the environmental contribution amount AK. However, the present disclosure is not limited to the case. When the contribution information DK is supplied from the printing apparatus 5, the control device 61 may control the display device 63 and the speaker 64 to execute one of display of the environmental contribution amount AK in the display device 63 and emission of the environmental contribution amount AK by the speaker 64.

### 2. Contribution Information Presentation Processing

As below, an example of the contribution information presentation processing will be described with reference to FIG. 8.

FIG. 8 is a flowchart showing an example of an operation of the control device 51 when the control device 51 performs the contribution information presentation processing. The contribution information presentation processing is executed, for example, when the power of the printing apparatus 5 is turned on and when the printing processing executed in the printing apparatus 5 is finished.

As shown in FIG. 8, in the contribution information presentation processing, the cartridge information acquisition unit 511 acquires the cartridge reuse information DQ2 from the cartridge 7 (S101).

Next, the server information acquisition unit 512 acquires the carbon dioxide emission information DC from the management server 1 via the terminal apparatus 6 (S103).

The server information acquisition unit 512 acquires the user history information DR from the management server 1 via the terminal apparatus 6 (S105).

The control device 51 acquires the cartridge use history information DX from the memory device 52 (S107).

Further, the control device 51 acquires the printing history information DY from the memory device 52 (S109).

Then, the contribution information generation unit 513 generates the contribution information DK based on the cartridge reuse information DQ2, the carbon dioxide emission information DC, the user history information DR, the cartridge use history information DX, and the printing history information DY acquired at steps S101 to S109 (S111).

Then, the notification device control unit 514 supplies the contribution information DK generated at step S111 to the terminal apparatus 6, and thereby, controls the terminal apparatus 6 to display the environmental contribution amount AK on the display device 63 provided in the terminal apparatus 6 and emit the environmental contribution amount AK by the speaker 64 provided in the terminal apparatus 6 (S113), and ends the contribution information presentation processing.

### 3. Conclusion of Embodiment

As described above, the printing apparatus 5 according to the embodiment includes the cartridge 7 that stores the ink used in the printing processing and executes the printing processing, and includes the cartridge information acquisition unit 511 acquiring the cartridge reuse information DQ2 on the reuse history of the cartridge 7, the contribution information generation unit 513, when the printing apparatus 5 includes the recycled cartridge 7X as the recycled product of the cartridge 7, generating the contribution information DK related to the environmental contribution amount AK as the contribution amount to the environment with the use of the recycled cartridge 7X based on the cartridge reuse information DQ2, and the notification device control unit 514 controlling the display device 63 to display the environmental contribution amount AK based on the contribution information DK.

As described above, according to the embodiment, the environmental contribution amount AK with the reuse of the cartridge 7 is displayed to the user UP, and thereby, the user UP is motivated to reuse the cartridge 7. Therefore, according to the embodiment, the user UP can be enlightened to reuse the cartridge 7 more strongly in comparison with a configuration without notification of the environmental contribution amount AK with the reuse of the cartridge 7 to the user UP. Thus, according to the embodiment, the greater contribution to “improve education, awareness-raising and human and institutional capacity on climate change mitigation, adaptation, impact reduction and early warning” described in Target 13.3 of the SDGs may be made in comparison with a configuration without notification of the environmental contribution amount AK with the reuse of the cartridge 7 to the user UP.

In the embodiment, the contribution information generation unit 513 generates the contribution information DK based on the number of the recycled cartridges 7X provided in the printing apparatus 5 in the past.

That is, according to the embodiment, the environmental contribution amount AK based on the number of the recycled cartridges 7X used in the past in the printing apparatus 5 is displayed to the user UP, and thereby, the user UP is motivated to reuse more cartridges 7 in the future. Therefore, according to the embodiment, the user UP can be enlightened to reuse more cartridges 7 in the future more strongly in comparison with a configuration without notification of the environmental contribution amount AK with the reuse of the cartridge 7 to the user UP. Thus, according to the embodiment, the greater contribution to “improve education, awareness-raising and human and institutional capacity on climate change mitigation, adaptation, impact reduction and early warning” described in Target 13.3 of the SDGs may be made in comparison with a configuration without notification of the environmental contribution amount AK with the reuse of the cartridge 7 to the user UP.

In the embodiment, the contribution information generation unit 513 generates the contribution information DK based on an amount of the eco-printing processing executed using the ink stored in the recycled cartridge 7X.

That is, according to the embodiment, the environmental contribution amount AK based on the amount of the eco-printing processing using the ink stored in the recycled cartridge 7X is displayed to the user UP, and thereby, the user UP is motivated to perform eco-printing processing using the ink stored in the recycled cartridge 7X. Therefore, according to the embodiment, the user UP can be enlightened to perform eco-printing processing using the ink stored in the recycled cartridge 7X more strongly in comparison with a configuration without notification of the environmental contribution amount AK with the reuse of the cartridge 7 to the user UP. Thus, according to the embodiment, the greater contribution to “improve education, awareness-raising and human and institutional capacity on climate change mitigation, adaptation, impact reduction and early warning” described in Target 13.3 of the SDGs may be made in comparison with a configuration without notification of the environmental contribution amount AK with the reuse of the cartridge 7 to the user UP.

Further, in the embodiment, the notification device control unit 514 controls the speaker 64 to provide notification of the environmental contribution amount AK based on the contribution information DK.

That is, according to the embodiment, the user UP is notified of the environmental contribution amount AK with the reuse of the cartridge 7 by the speaker 64. Therefore, according to the embodiment, the user UP with poor vision including the handicapped user UP and the aged user UP can be enlightened to reuse the cartridge 7 more strongly in comparison with a configuration without notification of the environmental contribution amount AK with the reuse of the cartridge 7 to the user UP. Thus, according to the embodiment, the greater contribution to “empower and promote the social, economic and political inclusion of all, irrespective of age, sex, disability, race, ethnicity, origin, religion or economic or other status” described in Target 10.2 of the SDGs may be made in comparison with a configuration without notification of the environmental contribution amount AK with the reuse of the cartridge 7 to the user UP.

In the embodiment, the contribution information DK includes information based on the carbon dioxide emission in the life cycle of the recycled cartridge 7X. Further, in the embodiment, the contribution information DK may be information related to the carbon dioxide emission in the life cycle of the recycled cartridge 7X.

That is, according to the embodiment, the environmental contribution amount AK based on the carbon dioxide emission in the life cycle of the recycled cartridge 7X is displayed to the user UP, and thereby, the user UP is motivated to reuse the cartridge 7. Therefore, according to the embodiment, the user UP can be enlightened to reuse the cartridge 7 more strongly in comparison with a configuration without notification of the environmental contribution amount AK with the reuse of the cartridge 7 to the user UP. Thus, according to the embodiment, the greater contribution to “improve education, awareness-raising and human and institutional capacity on climate change mitigation, adaptation, impact reduction and early warning” described in Target 13.3 of the SDGs may be made in comparison with a configuration without notification of the environmental contribution amount AK with the reuse of the cartridge 7 to the user UP.

In the embodiment, the cartridge 7 includes the memory device 70 that stores the cartridge reuse information DQ2, and the cartridge information acquisition unit 511 acquires the cartridge reuse information DQ2 from the memory device 70 of the cartridge 7 provided in the printing apparatus 5. In the embodiment, the memory device 70 is an example of “memory unit”.

Further, in the embodiment, the contribution information DK indicates the contribution amount to the environment when the recycled cartridge 7X is used in comparison with that when the new cartridge 7 is used in the printing apparatus 5.

That is, according to the embodiment, the contribution amount to the environment when the recycled cartridge 7X is used in comparison with that when the new cartridge 7 is used in the printing apparatus 5 is displayed to the user UP, and thereby, the user UP is motivated to reuse the cartridge 7. Therefore, according to the embodiment, the user UP can be enlightened to reuse the cartridge 7 more strongly in comparison with a configuration without notification of the environmental contribution amount AK with the reuse of the cartridge 7 to the user UP. Thus, according to the embodiment, the greater contribution to “improve education, awareness-raising and human and institutional capacity on climate change mitigation, adaptation, impact reduction and early warning” described in Target 13.3 of the SDGs may be made in comparison with a configuration without notification of the environmental contribution amount AK with the reuse of the cartridge 7 to the user UP.

### B. Modified Examples

The above described respective embodiments can be variously modified. Configurations of specific modifications will be exemplified as below. Two or more configurations optionally selected from the following exemplifications can be combined as appropriate as long as the configurations are mutually consistent. In the modifications exemplified below, elements having the same actions and functions as those of the embodiment have the same signs referred to in the above description, and the detailed description of the respective elements will be omitted as appropriate.

### Modified Example 1

In the above described embodiment, for convenience of description, the case where the environmental contribution amount AK includes the number of attached recycled products AK1, the number of uses of recycled products AK2, the cumulative number of uses of recycled products AK3, the eco-printing count AK4, the cumulative eco-printing count AK5, the eco-printing ratio AK6, the carbon dioxide reduction AK7, and the cumulative carbon dioxide reduction AK8 is described as an example, however, the present disclosure is not limited to the configuration. The environmental contribution amount AK may include part of the number of attached recycled products AK1, the number of uses of recycled products AK2, the cumulative number of uses of recycled products AK3, the eco-printing count AK4, the cumulative eco-printing count AK5, the eco-printing ratio AK6, the carbon dioxide reduction AK7, and the cumulative carbon dioxide reduction AK8.

### Modified Example 2

In the above described embodiment and modified example 1, the configuration in which the terminal apparatus 6 includes the display device 63 and the speaker 64 is described as an example, however, the present disclosure is not limited to the configuration. For example, the display device 63 may be provided in the printing apparatus 5. The speaker 64 may be provided in the printing apparatus 5.

### Modified Example 3

In the above described embodiment and the modified examples 1 and 2, the cartridge 7 provided in the printing apparatus 5 is described as an example as an object of management of the management system Sys, however, the present disclosure is not limited to the configuration. The object of management of the management system Sys may be any replaceable specific component provided in the electronic apparatus. That is, in the above described embodiment, the printing apparatus 5 is an example of “electronic apparatus”, and the cartridge 7 is an example of “specific component”.

Here, the specific component may be, for example, not only the cartridge 7 that stores the ink as a consumable item but also a storage container that stores a consumable item used in the printing apparatus 5 such as a toner bottle that stores toner as a consumable item. The specific component may be, for example, a storage container that stores a waste produced with the use of the printing apparatus 5 such as a waste ink box that stores waste ink as a waste or a waste toner box that stores waste toner as a waste.

Furthermore, the specific component is not limited to a component related to the printing apparatus 5. For example, the specific component may be a replaceable component provided in an electronic apparatus such as a lamp provided in a projector and a battery provided in a smartphone.

What is claimed is:

1. A printing apparatus including a storage container that stores a liquid used in printing processing and executing the printing processing, comprising:
an acquisition unit acquiring reuse information on a reuse history of the storage container;
a generation unit, when the printing apparatus includes a recycled storage container as a recycled product of the storage container, generating contribution information related to a contribution amount to an environment with use of the recycled storage container based on the reuse information; and
a device control unit controlling a display device to display the contribution amount based on the contribution information.

2. The printing apparatus according to claim 1, wherein
the generation unit generates the contribution information based on a number of recycled storage containers provided in the printing apparatus in the past.

3. The printing apparatus according to claim 1, wherein
the generation unit generates the contribution information based on an amount of the printing processing executed using the liquid stored in the recycled storage container.

4. The printing apparatus according to claim 1, wherein
the device control unit controls a speaker to provide notification of the contribution amount based on the contribution information.

5. The printing apparatus according to claim 1, wherein
the contribution information includes information based on carbon dioxide emission in a life cycle of the recycled storage container.

6. The printing apparatus according to claim 1, wherein
the storage container includes a memory unit that stores the reuse information, and
the acquisition unit acquires the reuse information from the memory unit of the storage container provided in the printing apparatus.

7. The printing apparatus according to claim 1, wherein
the contribution information indicates a contribution amount to an environment when the recycled storage container is used in comparison with that when a new product of the storage container is used in the printing apparatus.

8. An electronic apparatus including a replaceable specific component and executing specific processing, comprising:
an acquisition unit acquiring reuse information on a reuse history of the specific component;
a generation unit, when the electronic apparatus includes a recycled specific component as a recycled product the specific component, generating contribution of information related to a contribution amount to an environment with use of the recycled specific component based on the reuse information; and
a device control unit controlling a display device to display the contribution amount based on the contribution information.

9. The electronic apparatus according to claim 8, wherein
the generation unit generates the contribution information based on a number 4 recycled specific components provided in the electronic apparatus in the past.

10. The electronic apparatus according to claim 8, wherein
the generation unit generates the contribution information based on an amount of the specific processing executed using the recycled specific component.

11. The electronic apparatus according to claim 8, wherein
the device control unit controls a speaker to provide notification of the contribution amount based on the contribution information.

12. The electronic apparatus according to claim 8, wherein
the contribution information includes information based on carbon dioxide emission in a life cycle of the recycled specific component.

13. The electronic apparatus according to claim 8, wherein
the specific component includes a memory unit that stores the reuse information, and
the acquisition unit acquires the reuse information from the memory unit of the specific component attached to the electronic apparatus.

14. The electronic apparatus according to claim 8, wherein
the contribution information indicates a contribution amount to an environment when the recycled specific component is used in comparison with that when a new product of the specific component is used in the electronic apparatus.
